(19) United States
(12) Patent Application Publication
(10) Pub. No.: US 2017/0014846 A1
(43) Pub. Date: Jan. 19, 2017

(54) SPRINKLER HEAD GUARD

(71) Applicants: Peter A. Stathakos, Dix Hills, NY (US); Sofia Sideris, Bayside, NY (US)

(72) Inventors: Peter A. Stathakos, Dix Hills, NY (US); Sofia Sideris, Bayside, NY (US)

(21) Appl. No.: 14/803,093

(22) Filed: Jul. 19, 2015

(51) Int. Cl. B05B 15/00; A01G 25/00; B05B 15/10

(52) U.S. Cl. CPC B05B 15/001; B05B 15/10; A01G 25/00

(57) ABSTRACT

Apparatus are described that may serve as guards that protect partially buried sprinkler heads from impact damage. These apparatus each include an inner frame, an outer frame, and several wall members. The outer frame encircles the inner frame, and the wall members occupy the space between the two frames. The inner frame, the outer frame, and the wall members combine to partition the space into a plurality of compartments. At the same time, a top of the inner frame is higher than a top of the outer frame, and the wall members define a ramp between the top of the outer frame and the top of the inner frame. The apparatus may serve to cause a wheel of a lawnmower that would normally impact the sprinkler head to harmlessly pass over the sprinkler head without damage.

### FIELD OF THE INVENTION

The present invention relates generally to apparatus for providing irrigation, and, more particularly, to guards for preventing impact damage to sprinkler heads.

### BACKGROUND OF THE INVENTION

Pop-up sprinkler heads (or spray heads) are the most widely used type of irrigation head in residential and small commercial in-ground sprinkler systems. A pop-up sprinkler head is typically buried in the ground so its nozzle is about flush or slightly higher than the soil level when not in use. When water pressure is applied, a riser portion of the sprinkler head extends upward from its body so that the nozzle is placed above the soil level. When the water pressure is relieved, the riser and nozzle retract back into the body in response to a spring. There are a variety of nozzle designs to fit the contours of the landscape. For example, there are nozzles capable of providing a full arc, a half-circle, or a quarter circle of coverage.

Unfortunately, it is common for pop-up sprinkler heads to become damaged or displaced. A homeowner or gardener may, for example, run over a sprinkler head when mowing. Typically, such damage requires that the sprinkler head be unburied and a new sprinkler head be buried in its place. These types of repairs are both burdensome and expensive. At the same time, they frequently damage the grass in the region of the repair. There is, as a result, a need for apparatus capable of protecting sprinkler heads from this kind of impact damage.

### SUMMARY OF THE INVENTION

Embodiments of the present invention address the above-identified needs by providing apparatus for protecting sprinkler heads from impact damage.

Aspects of the invention are directed to an apparatus comprising an inner frame, an outer frame, and a plurality of wall members. The outer frame encircles the inner frame with a space therebetween. The plurality of wall members occupy the space, each wall member defining a respective lower wall member edge and a respective upper wall member edge. The inner frame, the outer frame, and the plurality of wall members combine to partition the space into a plurality of compartments. A top of the inner frame is higher than a top of the outer frame, and the plurality of wall members define a ramp between the top of the outer frame and the top of the inner frame.

Additional aspects of the invention are directed to an apparatus comprising a sprinkler head and a sprinkler guard, both partially buried in a portion of ground. The sprinkler guard comprises an inner frame, an outer frame, and a plurality of wall members. The inner frame encircles a portion of the sprinkler head. The outer frame encircles the inner frame with a space therebetween. The plurality of wall members occupy the space, each wall member defining a respective lower wall member edge and a respective upper wall member edge. The inner frame, the outer frame, and the plurality of wall members combine to partition the space into a plurality of compartments. A top of the inner frame is higher than a top of the outer frame, and the plurality of wall members define a ramp between the top of the outer frame and the top of the inner frame.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of a sprinkler guard in accordance with an illustrative embodiment of the invention;

FIG. 2 shows a plan view of the FIG. 1 sprinkler guard;

FIG. 3 shows a sectional view of the FIG. 1 sprinkler guard along the plane indicated in FIG. 1;

FIG. 4 shows a partially broken, exploded perspective view of the FIG. 1 sprinkler guard in combination with a sprinkler head buried in a portion of lawn;

FIG. 5 shows a partially broken perspective view of the FIG. 4 elements with the sprinkler guard positioned where it can protect the sprinkler head;

FIG. 6 shows a sectional view of the FIG. 4 elements positioned as indicated in FIG. 5;

FIGS. 7-9 show plan views of first, second, and third alternative sprinkler guards, respectively, in accordance with illustrative embodiments of the invention; and

FIG. 10 shows a perspective view of a fourth alternative sprinkler guard in accordance with an illustrative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

As used in the present specification and the appended claims, the term “substantially” means within reasonable manufacturing tolerances commonly used in the art.

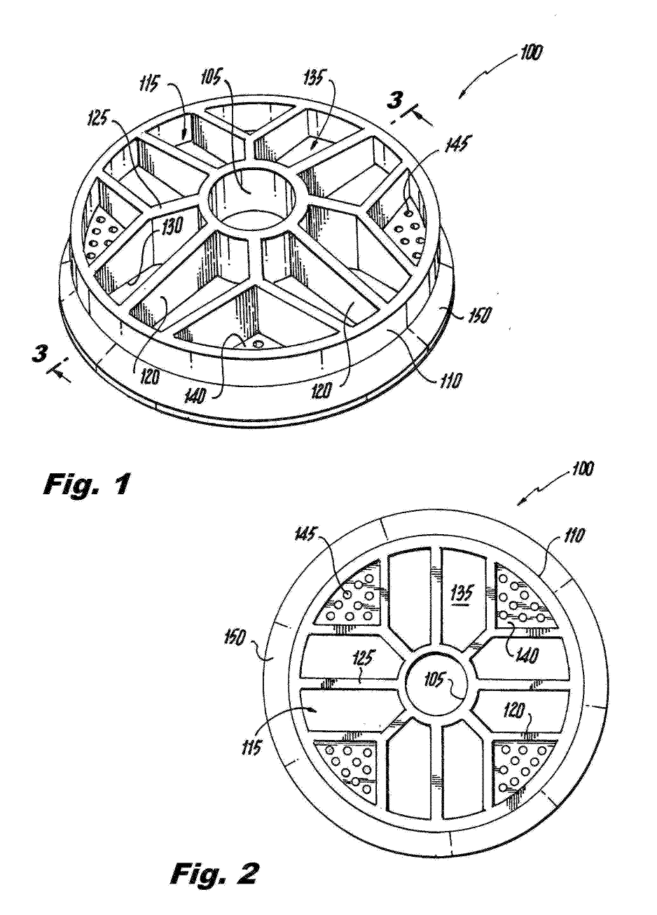

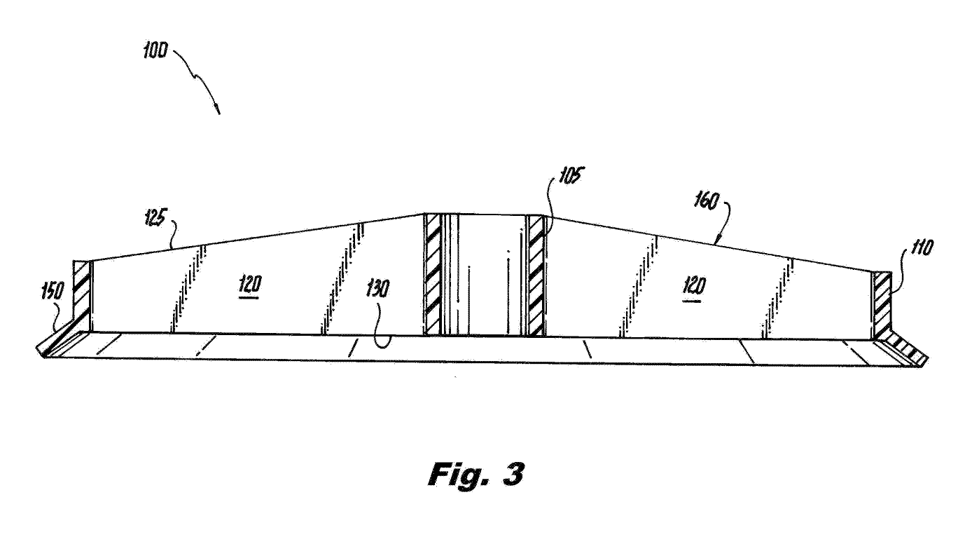

FIGS. 1-3 show various aspects of a sprinkler guard 100 (i.e., a form of apparatus) in accordance with an illustrative embodiment of the invention. FIG. 1 shows a perspective view, while FIG. 2 shows a plan view, and FIG. 3 shows a sectional view along the plane indicated in FIG. 1. As the name would suggest, the sprinkler guard 100 may be used to protect or guard a sprinkler head against impact damage.

The sprinkler guard 100 comprises an inner frame 105 and an outer frame 110, with the outer frame 110 encircling the inner frame 105 so as to define an annular space 115 between the frames 105, 110. In the present illustrative embodiment, both of the frames 105, 110 are substantially cylindrical. A plurality of wall members 120 occupy the space 115 between the frames 105, 110, with each wall member 120 defining a respective upper wall member edge 125 and a respective lower wall member edge 130. In some places, single wall members 120 span all the way between the inner and outer frames 105, 110, while, in other places, three shorter wall members 120 merge to form Y-shapes that span between the inner and outer frames 105, 110. In so doing, the wall members 120 combine with the inner and outer frames 105, 110 to partition the space 115 into a plurality of compartments 135. Floor plates 140 also occupy the space 115 between the inner and outer frames 105, 110. Each of the four floor plates 140 occupies a respective one of the twelve compartments 135, leaving eight of the compartments 135 open. Each of the floor plates 140 defines a set of openings 145 therein. Lastly, the sprinkler guard 100 further includes a lip 150 that extends from the outer frame 110 at an oblique angle.

The above-identified elements combine to form a unique three-dimensional shape that aids the sprinkler guard 100 in performing its function. With the sprinkler guard 100 oriented as shown in FIGS. 1 and 3 (i.e., with the top of the frame members 105, 110 horizontal), the wall members 120 are oriented substantially vertically while the floor plates 140 are oriented substantially perpendicular to the wall members 120 in a horizontal direction. At the same time, the top of the inner frame 105 is higher than the top of the outer frame 110, and the wall members 120 define a ramp 160 that linearly connects the top of the outer frame 110 to the top of the inner frame 105. Each of the wall members 120 are therefore characterized by a respective upper wall member edge 125 that is angled (i.e., non-parallel) with respect to its respective lower wall member edge 130. Because the inner and outer frames 105, 110 in the illustrative sprinkler guard 100 are cylindrical, the ramp 160 is annular.

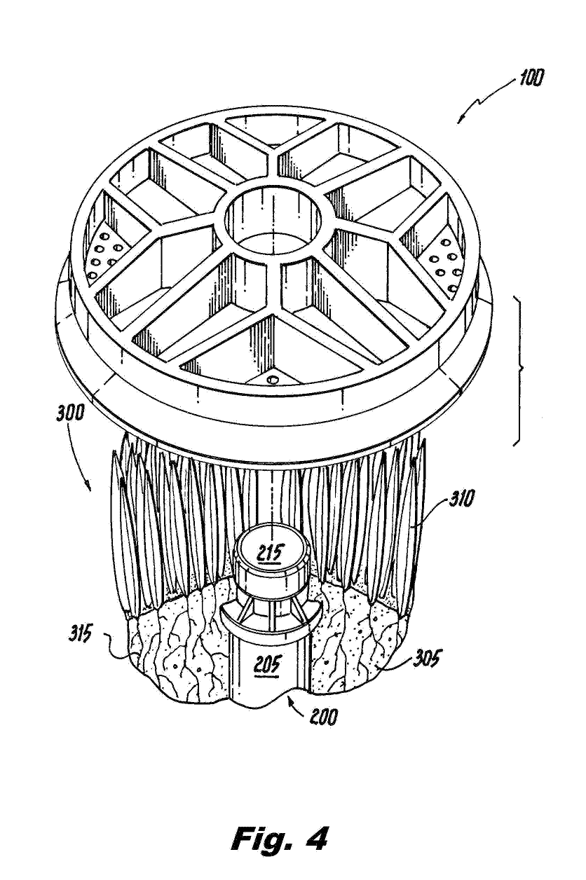

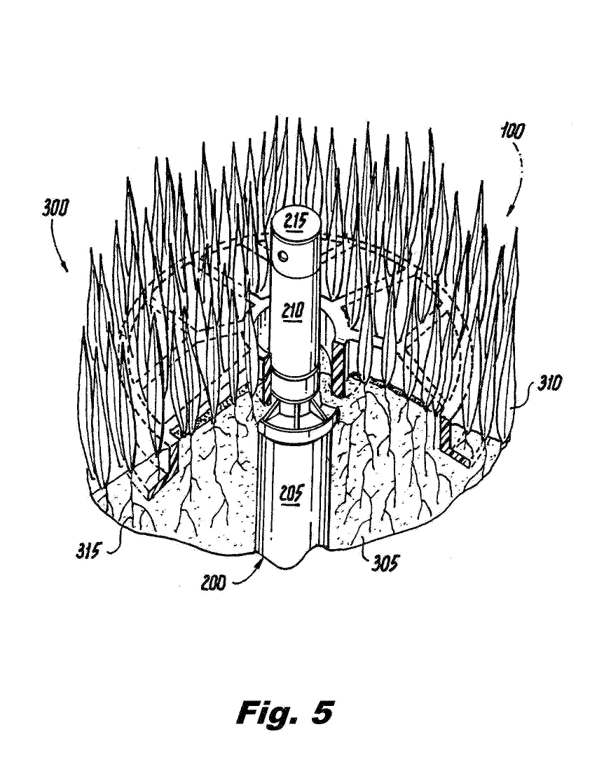

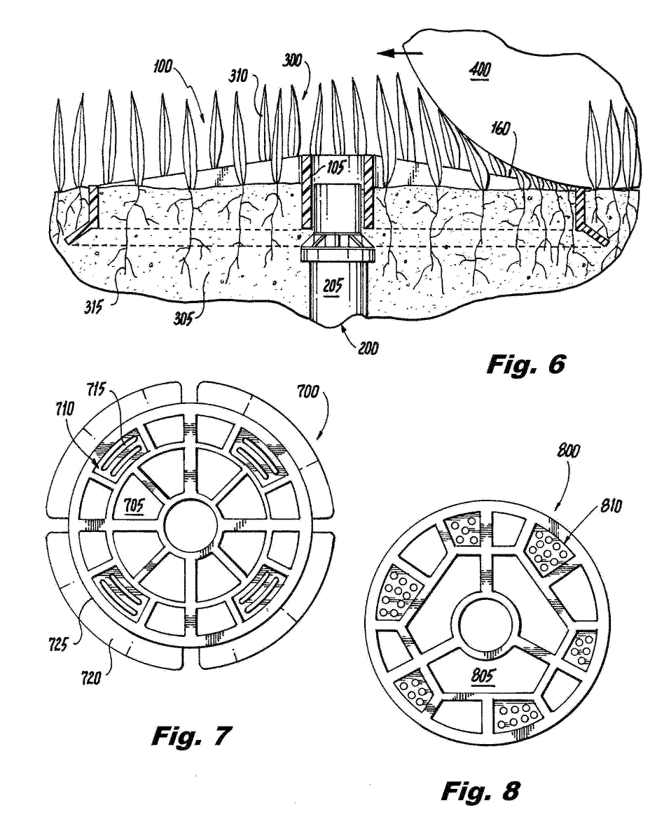

FIGS. 4-6 illustrate how the sprinkler guard 100 may be paired with a sprinkler head to protect that sprinkler head from damage. FIG. 4 shows an exploded perspective view of the sprinkler guard 100 in combination with a sprinkler head 200 buried in a portion of lawn 300 (i.e., a portion of ground) with the portion of lawn 300 partially cut away; while FIG. 5 shows a partially broken, perspective view of these elements with the sprinkler guard 100 partially buried in the portion of lawn 300 in a position where it can protect the sprinkler head 200. Finally, FIG. 6 shows a sectional view of these elements along the same plane indicated in FIG. 1 with the sprinkler guard 100 again in a position where it can protect the sprinkler head 200. The portion of lawn 300 itself comprises soil 305, and grass 310 with its roots 315 growing into the soil 305.

In these views, the sprinkler head 200 is of the common pop-variety and includes a body 205, a riser 210, and a nozzle 215. Without applied water pressure, as shown in FIGS. 4 and 6, the sprinkler head 200 is buried so that its top is about flush with the top of the soil 305, and the riser 210 and the nozzle 215 sit within the body 205. When water pressure is applied to the sprinkler head 200, as shown in FIG. 5, the riser 210 rises from the body 205 and positions the nozzle 215 above the grass 310. Water emanating from the nozzle 215 is thereby able to irrigate the surrounding area.

When positioning the sprinkler guard 100 to protect the sprinkler head 200, the sprinkler guard 100 is preferably positioned such that the top of the sprinkler head 200 is surrounded by the inner frame 105 with the sprinkler guard 100 partially buried in the soil 305 so that the top of the outer frame 110 is about level with the top of the soil 305. Burying the sprinkler guard 100 in this manner places soil 305 and grass 310 within the many compartments 135 of the sprinkler guard 100, including in those compartments 135 where the floor plates 140 are provided. At the same time, such placement places the top of the inner frame 105 above the top of the sprinkler head 200 when the sprinkler head 200 is deactivated and not receiving pressurized water. When water pressure is applied, the riser 210 lifts the nozzle 215 above the top of the inner frame 105, allowing the nozzle 215 to provide water coverage unimpeded.

To achieve this kind of placement, a user being instructed as how to install the sprinkler guard 100 onto the existing sprinkler head 200 may be instructed to initially dig up a circular region around the sprinkler head 200 of a diameter about equal to the diameter of the sprinkler guard 100 to a depth about equal to the height of the outer frame 110. The user may then be instructed to place the sprinkler guard 100 into this recessed region so that the inner frame 105 surrounds the protruding portion of the sprinkler head 200 and the sprinkler guard 100 is resting on the surrounding soil 305 with the tops of the frames 105, 110 being about horizontal. The user may then be instructed to fill the compartments 135 of the sprinkler guard 100 with soil 305 to about the top of the outer frame 110, including those compartments 135 comprising floor plates 140. Finally, the user may be instructed to plant grass 310 in this soil 305.

Installed in this manner, it is anticipated that the roots 315 from any grass 310 growing in the compartments 135 of the sprinkler guard 100 will rapidly grow into the soil 305 to a depth below the sprinkler guard 100, as shown in FIGS. 5 and 6. This will occur in those compartments 135 both with and without the floor plates 140 because of the openings 145. At the same time, these openings 145 also provide a means of drainage in those compartments 135 with floor plates 140.

Advantageously, when properly installed, the sprinkler guard 100 will display excellent lateral stability (i.e., resistance to lateral movement) and excellent vertical stability (i.e., resistance to vertical movement). Lateral stability is enhanced by the soil 305 and the grass 310 that occupy the compartments 135 in combination with the roots 315 that extend below the sprinkler guard 100 into the underlying soil 305. The roots 315 help to anchor the soil 305 and the grass 310, and, in so doing, help to anchor the sprinkler guard 100. Vertical stability is enhanced by the floor plates 140 as well as the lip 150. These elements are simultaneously supported by the underlying soil 305 while being pressed downward by the weight of the overlying soil 305, strongly inhibiting vertical motion. Thus, once properly installed, the sprinkler guard 100 is unlikely to move.

As indicated above, a purpose of the sprinkler guard 100 is to protect its sprinkler head 200 from unintended impact damage such as that caused by a wheel running over the sprinkler head 200. FIG. 6 diagrammatically shows how this protection is provided with respect to a wheel 400 that is about to pass over the sprinkler head 200. Rather than impacting the sprinkler head 200, the ramp 160 and the inner frame 105 cause the wheel 400 to harmlessly pass over the sprinkler head 200 without contact. The need for expensive and time consuming repairs to the sprinkler head 200 is thereby avoided. Because of the symmetry of the sprinkler guard 100, a wheel approaching the sprinkler head 200 from any direction may be made to innocuously pass over the sprinkler head 200 in this manner.

Once understood from the description provided herein, the sprinkler guard 100 may be formed from conventional materials utilizing conventional manufacturing techniques. The sprinkler guard 100 may, for example, be formed of plastic manufactured via injection molding. Alternatively, the sprinkler guard 100 may be formed of metal and cast. Nevertheless, other equally suitable materials and/or manufacturing techniques may be utilized, and the results will still come within the scope of the invention.

It should again be emphasized that the above-described embodiment of the invention is intended to be illustrative only. Other embodiments can use different types and arrangements of elements for implementing the described functionality. These numerous alternative embodiments within the scope of the appended claims will be apparent to one skilled in the art.

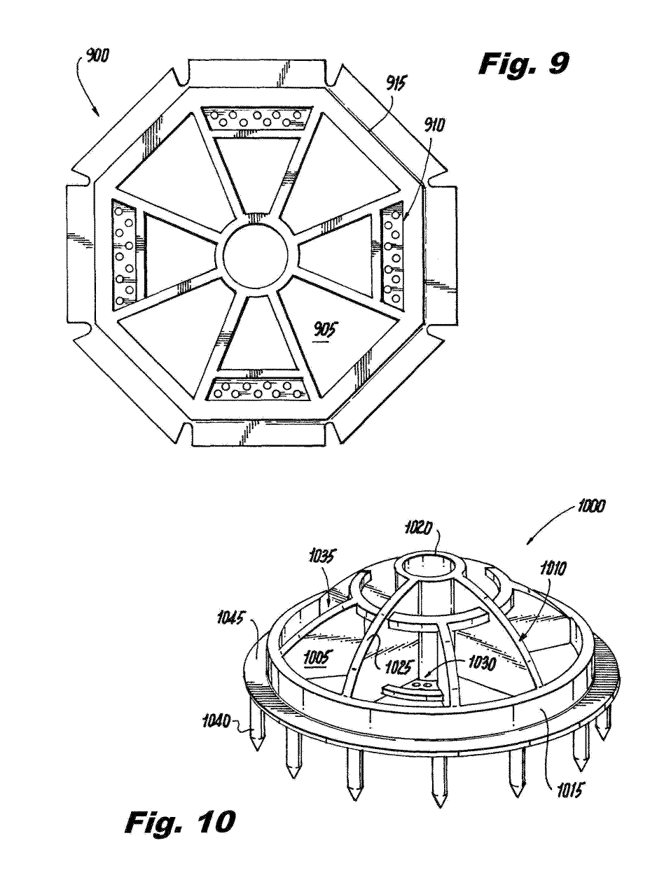

FIGS. 7-9 show plan views of alternative designs for sprinkler guards that fall within the scope of the invention. In each case, the number of wall members and the pattern of compartments are very different from those in the sprinkler guard 100. In FIG. 7, for example, a first alternative sprinkler guard 700 comprises 20 compartments 705 with four of those compartments being occupied by floor plates 710. The floor plates 710 have slots 715 rather than round openings passing therethrough. At the same time, rather than having a single continuous lip that extends from its outer frame, the first alternative sprinkler guard 700 includes a plurality of lips 720 that extend from an outer frame 725. As another example, in FIG. 8, a second alternative sprinkler guard 800 comprises fifteen compartments 805 with six floor plates 810, and is devoid of an outer lip altogether. As even one more example, in FIG. 9, a third alternative sprinkler guard 900 comprises twelve compartments 905 with four floor plates 910 and an outer frame 915 that is octagonal rather than being cylindrical. While an octagonal shape is shown, alternative embodiments may have outer frames that are polygonal with fewer or greater than eight sides.

Lastly, FIG. 10 shows a perspective view of an fourth alternative sprinkler guard 1000 falling within the scope of the invention. Notably, in this particular illustrative embodiment, wall members 1005 form a curved annular ramp 1010 between an outside frame 1015 and an inside frame 1020 rather than a linear ramp in the manner of the sprinkler guard 100. The wall members 1005 are therefore characterized by upper wall member edges 1025 that are curved. Floor plates 1030 in the fourth alternative sprinkler guard 1000 also do not occupy entire compartments 1035 in the manner of the previous embodiments, but occupy only portions of the compartments 1035. Finally, the fourth alternative sprinkler guard 1000 also includes a plurality of spikes 1040 that project downward from an outside lip 1045. These spikes 1050, when pressed into soil, may provide even greater lateral stability to the fourth alternative sprinkler guard 1000.

Thus, embodiments falling within the scope of the invention may comprise wall members with upper wall member edges that form linear ramps between their outer and inner frames, or wall members with upper wall member edges that form curved ramps between these frames. It is even further contemplated that alternative embodiments may comprise wall members that define ramps that are both partially linear and partially curved, or ramps that have two or more linear sections with differing slopes. A ramp formed by the wall members, moreover, may also include level sections between the inner and outer frames, as desired.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An apparatus comprising:
an inner frame;
an outer frame encircling the inner frame with a space therebetween; and
a plurality of wall members occupying the space, each wall member defining a respective lower wall member edge and a respective upper wall member edge;
wherein:
the inner frame, the outer frame, and the plurality of wall members combine to partition the space into a plurality of compartments;
a top of the inner frame is higher than a top of the outer frame; and
the plurality of wall members define a ramp between the top of the outer frame and the top of the inner frame.

2. The apparatus of claim 1, wherein the inner frame is substantially cylindrical.

3. The apparatus of claim 1, wherein the outer frame is substantially cylindrical.

4. The apparatus of claim 1, wherein the outer frame is substantially polygonal.

5. The apparatus of claim 1, wherein the plurality of wall members are oriented substantially vertically when the top of the inner frame is horizontal.

6. The apparatus of claim 1, wherein at least a portion of the ramp is linear.

7. The apparatus of claim 1, wherein at least a portion of the ramp is curved.

8. The apparatus of claim 1, wherein at least a portion of the plurality of wall members define respective upper wall member edges that are nonparallel with their respective lower wall member edges.

9. The apparatus of claim 1, wherein at least a portion of the plurality of wall members define upper wall member edges that are curved.

10. The apparatus of claim 1, further comprising a plurality of floor plates in the space, each floor plate oriented substantially perpendicular to the plurality of wall members.

11. The apparatus of claim 10, wherein each of the plurality of floor plates occupies a respective one of the plurality of compartments.

12. The apparatus of claim 11, wherein only a fraction of the plurality of compartments are occupied by the plurality of floor plates.

13. The apparatus of claim 10, wherein each of the plurality of floor plates defines one or more respective openings therethrough.

14. The apparatus of claim 1, further comprising a lip extending from the outer frame.

15. The apparatus of claim 14, wherein the lip extends from the outer frame at an oblique angle.

16. The apparatus of claim 14, further comprising a plurality of spikes projecting from the lip.

17. The apparatus of claim 1, wherein the inner frame is dimensioned to be operative to surround at least a portion of a body of a sprinkler head.

18. An apparatus comprising:
a sprinkler head partially buried in a portion of ground; and
a sprinkler guard partially buried in the portion of ground and comprising:
an inner frame encircling a portion of the sprinkler head;
an outer frame encircling the inner frame with a space therebetween;
a plurality of wall members occupying the space, each wall member defining a respective lower wall member edge and a respective upper wall member edge;
wherein:
the inner frame, the outer frame, and the plurality of wall members combine to partition the space into a plurality of compartments;
a top of the inner frame is higher than a top of the outer frame; and
the plurality of wall members define a ramp between the top of the outer frame and the top of the inner frame.

19. The apparatus of claim 18, wherein the sprinkler guard is shaped such that a wheel rolling over the inner frame will not impact the sprinkler head.

20. The apparatus of claim 19, wherein the portion of ground supports grass with roots that pass through the sprinkler guard into soil below the sprinkler guard.
